(19) United States
(12) Patent Application Publication
(10) Pub. No.: US 2008/0122749 A1
(43) Pub. Date: May 29, 2008

(54) Method of driving plasma display panel

(76) Inventors: Yong Duk Kim, Gumi-si (KR); Young Jun Lee, Gumi-si (KR); Jung Hoon Lee, Gumi-si (KR); Su Sam Choi, Gumi-si (KR)

Correspondence Address: DICKSTEIN SHAPIRO LLP, 1825 EYE STREET NW, Washington, DC, 20006-5403, US

(21) Appl. No.: 11/604,737

(22) Filed: Nov. 28, 2006

(51) Int. Cl. G09G 3/28

(52) U.S. Cl. 345/63

(57) ABSTRACT

A method of driving a plasma display panel is disclosed, in which the plasma display panel includes one frame divided into a plurality of subfields, the subfield being classified into a reset period, an address period, and a sustain period in order to display a gray scale of the panel by discharge of the subfields. The method includes gradually decreasing a voltage level of a scan electrode at a ending point of ramp-down in each reset period, a voltage level of a scan pulse applied to a selected scan electrode in the address period, or a voltage level of a sustain electrode according to progress of the subfields, thereby improving a stable and rapid address discharge characteristic of the plasma display panel and increasing luminance and contrast ratio of the plasma display panel by obtaining a sufficient sustain discharge time.

### BACKGROUND OF THE INVENTION

1. Field of the Invention

The present invention relates to a method of driving a plasma display panel, and more particularly, to a method of driving a plasma display panel which can improve address discharge characteristic of the plasma display panel by reforming waveforms of a pulse applied to a scan electrode (i.e., Y electrode) and a sustain electrode (i.e., X electrode) and also can increase luminance and contrast ratio of the plasma display panel by obtaining a sufficient sustain of discharge time.

2. Discussion of the Related Art

Recently, a flat panel display is an object of interest by virtue of reducing the weight and volume of CRTs. Such a flat panel display comprises an LCD (Liquid Crystal Display), a PDP (Plasma Display Panel), an FED (Field Emission Display), and an EL (Electro-Luminescence).

Among the above flat panel displays, the PDP displays images including characters or graphics and moving pictures by making phosphors emit light with a UV-ray radiating from the discharge of inert mixed gases (e.g., He+Xe, Ne+Xe, or He+Xe+Ne). Such a PDP has advantages of thinning and widening the panel, and provides a greatly improved quality of image due to the recent development of technology.

In particular, a 3-electrode AC surface discharge type of PDP has advantages of extended life time and driving with low since wall charges are accumulated on a dielectric layer at the discharge of the PDP to lower the voltage required for the discharge and the electrodes are protected from sputtering of plasma.

FIG. 1 is a perspective view illustrating the structure of a 3-electrode AC surface discharge type of PDP.

The PDP includes a front substrate 10 with an X electrode and a Y electrode formed thereon, and a rear substrate 20 with an address electrode A formed thereon, the front substrate 10 and the rear substrate 20 being spaced apart from each other at a specified interval and hermitically engaged to each other in parallel.

The X electrode (i.e., a sustain electrode) and the Y electrode (i.e., a scan electrode) formed on the front substrate 10 are to maintain the emission of a cell by mutual discharge in one pixel. The X electrode and the Y electrode consist of transparent electrodes (ITO electrode) X1 and Y1 made of a transparent ITO substance, and bus electrodes X2 and Y2 made of a metal substance. A dielectric layer 12 isolating a pair of electrodes is deposited on X and Y electrodes to control discharge current. A protective layer 13 generally formed of MgO is deposited on the dielectric layer 12.

Meanwhile, the rear substrate 20 includes strip-type (alternatively, dot-type) partitions 21 arrayed in parallel to define a plurality of discharge spaces, that is, cells C, address electrodes A disposed parallel with the partitions 21 across the electrodes X and Y, and a dielectric layer 23 formed on the address electrodes A. An R.G.B. phosphor layer 24 is applied on an upper side of the rear substrate 20, except for upper end surfaces of the partitions 21, to emit visible rays for image display upon the address discharge.

The PDP operates one frame of 16.67 ms corresponding to 1/60 second by dividing it into several subfields having different luminous times in order to obtain gray level of a picture. Each of the subfields is divided into a reset period for obtaining a stable discharge characteristic regularly, an address period for selecting a discharge cell, and a sustain period for obtaining a gray level according to the discharge times for maintaining the discharge of the cells selected at the address period.

In this instance, the important consideration to design a waveform of the reset period is to make a uniform and stable address condition by minimizing a difference of the discharge condition of all cells. Black luminance (in case all cells in the panel are not selected) has to be decreased by minimizing the discharge in the reset period so as to obtain a high contrast ratio. In addition, it is important to assign for the maximum time in the sustain period, thereby obtaining the high luminance.

A ramp-type waveform is widely used as the waveform of the reset period of the subfield which is a driving waveform of a conventional PDP. The ramp-type waveform minimizes a deviation of the discharge condition of all cells by accurately controlling the wall charge, thereby enabling the address operation to carry out stably and rapidly. Since the ramp-type waveform reduces the quantity of the emitting light, the black luminance is low in comparison to that using a square wave, thereby obtaining a relatively high contrast ratio.

FIG. 2 is a diagram of a ramp waveform of a reset period according to a prior art (WO 00/19400 and EP 0967589).

Referring to FIG. 2, the reset period of each subfield has a ramp-up period, in which voltage rises continuously with a constant slope, and a ramp-down period, in which voltage falls continuously and constantly. Explaining the drive of the PDP using such a pulse shape, first of all, during the ramp-up period of the rest period, the Y electrode becomes an anode, while the X electrode and the A electrode become a cathode, thereby causing weak discharge. As a result, positive wall charges are sufficiently accumulated on the X electrode and the A electrode, while negative wall charges are sufficiently accumulated on the Y electrode. During the ramp-down period, the Y electrode becomes a cathode, while the X electrode and the A electrode become an anode, thereby causing the discharge. As such, the uniform and stable address condition suitable for the discharge condition of each cell is enabled in all cells at the ending point of the ramp-down.

In the prior art, the ramp waveform having the ramp-up and ramp-down periods is applied for each subfield. In the case of black pattern that does not cause the sustain discharge, since the ramp pulse is repeatedly applied in all subfields as a reset waveform, the black luminance is the sum of luminance diverged by the ramp discharge in the reset period in each subfield. Therefore, there is a drawback in that the high contrast ratio cannot be obtained. In addition, since the time required for the reset period in one frame is long, the time assigned for the sustain discharge is shortened, and thus it is difficult to obtain the high luminance.

FIG. 3 is a diagram of a waveform according to another prior art (EP 1022715 A2) so as to solve the above problem mentioned in the prior art shown in FIG. 2.

Referring to FIG. 3, only the first subfield has a reset period having both ramp-up period and ramp-down period, and other subfields have only ramp-down period in one frame. The operation principle using the pulse is as followings.

All cells are appointed with the address condition through weak discharge resulted from ramp reset having both ramp-up and ramp-down in the first subfield. Then, a scan pulse and a data pulse are respectively applied to the Y electrode and the A electrode in the address period, and address discharge occurs to store wall charges enough to cause sustain discharge by sustain pulses, so that cells to be ON are selected. Then, the sustain discharge occurs in the ON cells selected in the previous address period, while the sustain discharge does not occur in non-selected OFF cell. The ON cells sufficiently store the wall charges on each electrode through the last sustain discharge before the ramp reset having only the ramp-down period, so that it is in the state the discharge occurs during the ramp-down period. The cells are discharged in the ramp reset having only the ramp-down period, and thus are in the same state as that at the ending point of the ramp-down of the first subfield. Meanwhile, in case of the OFF cells, since the discharge does not occurs in the address and sustain periods after the reset period of the first subfield, there is no variation of the wall charge. Therefore, the discharge does not occur in the reset period of a subsequent subfield. In case of representing the black pattern, all cells of the panel carry out the weak discharge at the same time in the reset period of the first subfield containing both ramp-up period and ramp-down period, and then do not carry out the weak discharge in the address and sustain periods. Accordingly, the black luminance is achieved by the weak discharge in the ramp reset of the first subfield containing both ramp-up period and ramp-down period, thereby obtaining the very high contrast ratio. In addition, it is preferable to obtain the high luminance since the time for the ramp-up period is assigned for the time required for the sustain discharge.

However, the case of FIG. 3 has a drawback in that the address condition becomes worse as time goes by. That is, the wall charges generated by the ramp reset are set to each cell so that all cells have the uniform characteristic under the condition of the subsequent address discharge. In case the discharge does not occur, it has to be maintained as it is. However, the conditions of wall charges and discharge of each electrode controlled by the ramp reset of the subfield containing both ramp-up period and ramp-down period are not maintained as it is with the lapse of time. It is likely that the condition of the address discharge becomes worse. It is caused by disappearance of the vacuum charged particles charges with the lapse of time after the reset discharge, disappearance of the wall charges due to recombination thereof, or inflow/outflow of the charges due to address discharge or sustain discharge of adjacent cell. In case some subfields are maintained in an off state, without carrying out the address discharge and the sustain discharge, after the reset discharge of the subfield containing both ramp-up period and ramp-down period, and then the address discharge occurs in the cells in any subfield, it is quite probable that there is mis-addressing cell in which addressing is missed due to the varied conditions of the wall charge and discharge with the lapse of time. In case the address discharge occurs in the ramp reset of the subfield containing both ramp-up period and ramp-down period, and an initialization state is existed in the subfield containing only ramp-down reset, there is probably the mis-addressing cell as described above, if the address discharge and the sustain discharge do not occur after that.

### SUMMARY OF THE INVENTION

Accordingly, the present invention is directed to a method of driving a plasma display panel that substantially obviates one or more problems due to limitations and disadvantages of the related art.

An object of the present invention is to provide a method of driving a plasma display panel which can improve a stable and rapid address discharge characteristic of the plasma display panel by reforming a waveform of the pulse applied to a Y electrode and an X electrode and also can increase contrast ratio by improvement of luminance of the plasma display panel.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method of driving a plasma display panel including one frame divided into a plurality of subfields, the subfield being classified into a reset period, an address period, and a sustain period in order to display a gray scale of the panel by discharge of the subfields, according to the present invention, which includes gradually decreasing a voltage level of a scan electrode (Y electrode) at a ending point of ramp-down in each reset period, according to progress of the subfields.

According to another aspect of the present invention, a method of driving a plasma display panel includes gradually decreasing a voltage level of a scan pulse applied to a scan electrode selected at scanning in each reset period, according to progress of the subfields.

According to further another aspect of the present invention, a method of driving a plasma display panel includes gradually decreasing a voltage level of a sustain electrode (X electrode) at a ending point of ramp-down in each reset period, according to progress of the subfields.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating the structure of a 3-electrode AC surface discharge type of PDP;

FIG. 2 is a diagram of a ramp waveform of a reset period according to a prior art;

FIG. 3 is a diagram of a waveform according to another prior art so as to solve the above problem mentioned in the prior art shown in FIG. 2;

FIG. 4 is a diagram of a reset waveform according to a first embodiment of the present invention;

FIG. 5 is a diagram illustrating variations of a voltage level V_{yd} of a Y electrode at a ending point of a ramp-down of each subfield;

FIG. 6 is a diagram of the waveform applied to a Y electrode according to a second embodiment of the present invention;

FIGS. 7 and 8 are diagrams of the waveform applied to a Y electrode according to a third embodiment of the present invention;

FIG. 9 is a diagram of the waveform applied to a Y electrode according to a fourth embodiment of the present invention;

FIGS. 10 and 11 are diagrams of the waveform applied to an X electrode according to a fifth embodiment of the present invention;

FIG. 12 is a diagram of the waveform applied to an X electrode for each subfield; and

FIG. 13 is a diagram of a waveform of a pulse according to a sixth embodiment of the present invention.

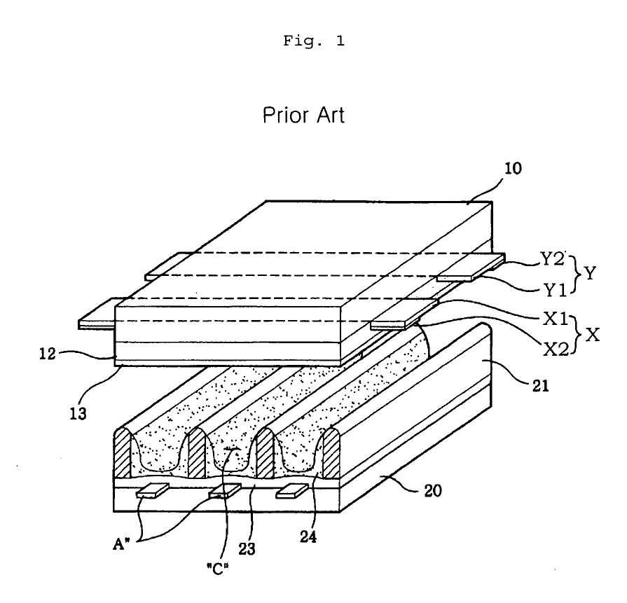

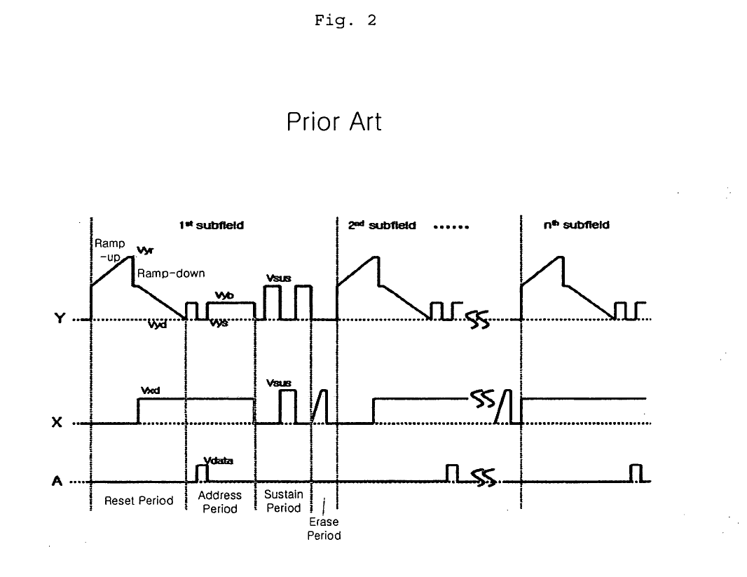

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

FIG. 4 is a diagram of a reset waveform according to a first embodiment of the present invention.

As a common ADS (Address and Display Seperated) driving method to display an image, one frame is divided into n subfields, and each subfield is classified into a reset period, an address period, and a sustain period. A waveform of a pulse in the reset period uses a ramp waveform as the prior art. The embodiment will now be described with reference to the case in which a reset pulse containing both ramp-up period and ramp-down period is applied in the first subfield among a plurality of subfields constructing one frame, while a reset pulse containing only a ramp-down period is applied in the remaining subfields, but the present invention is not limited thereto.

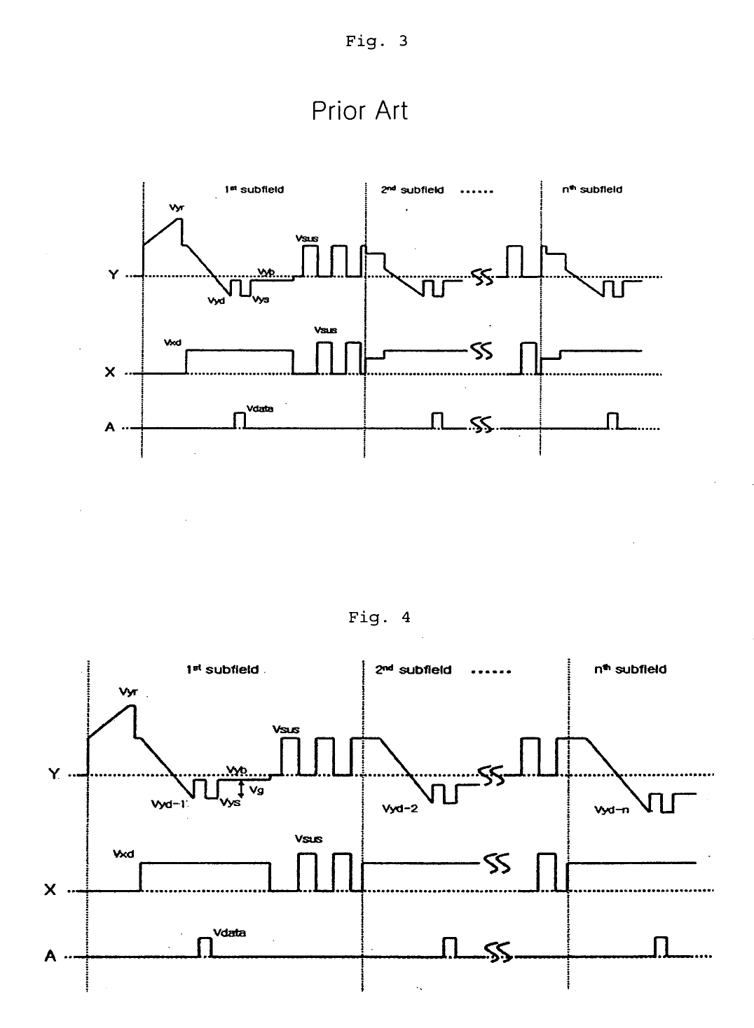

This embodiment is characterized by gradually decreasing a voltage level V_{yd} of a Y electrode at the ending point of a ramp-down of each subfield, according to a specific rule. That is, the voltage level of the Y electrode is constantly maintained at V_{yd} at the ending point of the ramp-down in all subfields, as shown in FIG. 3, while the voltage level V_{yd} of the Y electrode is gradually decreased as V_{yd-1}, V_{yd-2}, . . . , and V_{yd-n} according to a progress sequence of the subfields at the ending point of the ramp-down in each subfield. In this instance, the voltage level of the Y electrode selected at scanning in the address period of each subfield, i.e., a voltage level V_{ys} of a scan pulse, is equal to the voltage levels V_{yd-1}, V_{yd-2}, . . . , and V_{yd-n}, of the Y electrode at the ending point of the ramp-down in the reset period, and a voltage difference V_{g} between the voltage level V_{ys} of the selected Y electrode and a voltage V_{yb} of the non-selected Y electrode is constantly maintained in all subfields.

The reason why the voltage level V_{yd} of the Y electrode is gradually decreased in the subsequent subfield at the ending point of the ramp-down according to the progress sequence of the subfields is to improve an addressing condition and a sustain discharge condition.

More specifically, the conditions between the electrodes X-Y and between the electrodes A-Y should satisfy Equations 1 and 2 below at the ending point of the ramp-down in each reset period.

V_{fxy}(firing voltage between X and Y electrodes when X electrode is an anode)=V_{axy}(voltage applied to Xand Y electrodes)+V_{wxy}(wall voltage between X and Y electrodes) [Equation 1]

V_{fay}(firing voltage between A and Y electrodes when A electrode is an anode)=V_{ary}(voltage applied to A and Y electrodes)+V_{way}(wall voltage between X and Y electrodes) [Equation 2]

The finally applied voltage V_{A} becomes a voltage difference between X and Y electrodes and between A and Y electrodes according to the voltage applied to each X, Y, and A electrode at the ending point of the ramp-down. At that time, the finally applied voltage between X and Y electrodes and between A and Y electrodes satisfies Equations 3 and 4 below.

V_{axy}(voltage applied to X and Y electrodes)=V_{xd}(voltage applied to X electrode)−V_{yd}(voltage applied to Y electrode) [Equation 3]

V_{aay}(voltage applied to A and Y electrodes)=0V(A electrode is zero voltage)−V_{yd}(voltage applied to Y electrode) [Equation 4]

As can be known from Equations 1 and 2, if the voltage Vₐ is applied to each electrode (X, Y, and A) in the state in which the wall charges are stored, the difference between the electrodes exceeds the firing voltage V_{f}, thereby causing the discharge. In this instance, as known from Equations 3 and 4, the voltage is applied to the Y electrode as a cathode, while the voltage is applied to the A electrode as an anode, thereby further causing the discharge.

More specifically, since the voltage of each electrode is not varied at the ending point of the ramp-down in all subfield as the prior art shown in FIG. 3, the voltage Vₐ applied to all electrodes is equal to each other. Accordingly, the wall voltage V_{w} is almost not varied or very slightly varied in the OFF cells, in which the sustain discharge does not occur in the previous subfield. After that, since the applied voltage Va is not varied in the reset period of the subfield, the weak discharge does not occur in the reset period. However, by lowering the voltage level V_{yd} of the Y electrode relative to the previous subfield at the ending point of the ramp-down, the present invention has an effect like that the voltage Vₐ higher than that in the previous subfield is applied between X and Y electrodes and between A and Y electrodes. Thus, in the previous subfield, the OFF cell not carrying out the sustain discharge causes the discharge corresponding to the voltage of the Y electrode which is lowered in the subfields containing only ramp-down period, as well as the ON cell carrying out the sustain discharge, so that a further weak discharge occurs in the OFF cell. As such, the vacuum charges that were disappeared in the OFF cell are again generated, and the wall charges that were slightly varied are again accumulated stably, thereby again setting the address conditions that were varied. Consequently, the possibility of mis-addressing is greatly reduced, and the stable and rapid address discharge characteristic can be obtained.

In addition, the reset period containing both ramp-up period and ramp-down period in one frame is only one, and the discharge amount generated by applying the voltage at the ending point of the ramp-down according to the progress of the subfield is very slight. Therefore, the present invention can have a characteristic of the high contrast ratio. Also, since a time for the ramp-up is not required in the reset period, the time can be assigned for the sustain discharge time, thereby increasing the luminance.

In this instance, the voltage level of the Y electrode to be decreased at the ending point of the ramp-down according to the progress of the subfield can be changed in various modes.

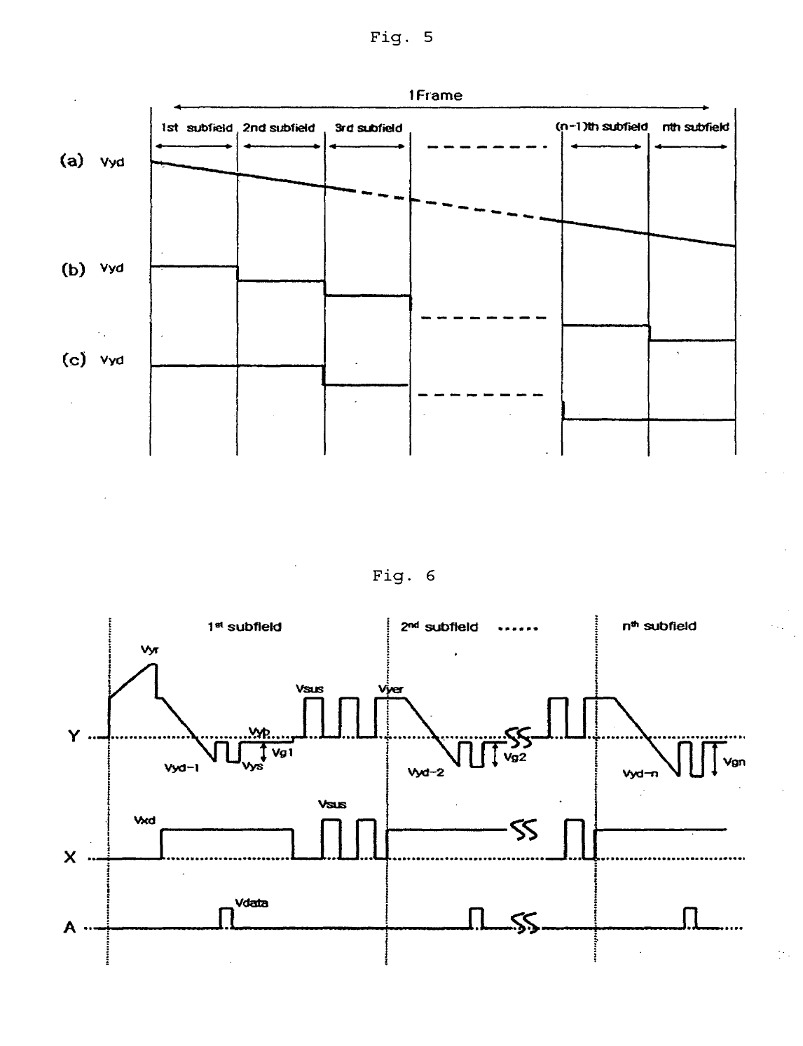

FIG. 5 is a diagram illustrating variations of the voltage level V_{yd} of the Y electrode at the ending point of the ramp-down of each subfield.

Referring to FIG. 5a, the voltage level of the Y electrode at the ending point of the ramp-down is further lowered in the subsequent subfield according to the progress of the subfield, in comparison to the previous subfield. At the same time, the voltage level V_{yd} for each Y electrode is gradually decreased in the address period of the same subfield according to the sequence of the Y electrode to be scanned. In this instance, a variation rate of the voltage level V_{yd} between the Y electrodes in each subfield is equal to each other. Consequently, the voltage level V_{yd} is gradually decreased at a constant ratio for each Y electrode according to the sequence of the Y electrodes to be scanned from the first subfield to the last subfield during one frame period, so that it is reduced as a straight line having a constant slope, as shown in FIG. 5a. Although not shown in the drawings, a reduction rate (slope of the straight line) of the voltage for each subfield may be different from each other.

Referring to FIG. 5b, it makes equal the voltage level V_{yd} of each Y electrode at the ending point of the ramp-down in the same subfield, different from FIG. 5a. However, the voltage level V_{yd} is decreased at a constant ratio in stages between the neighbor subfields according to the progress of the subfield. Consequently, the voltage level V_{yd} is decreased as a step at a constant ratio in each subfield during one frame, as shown in FIG. 5b.

Referring to FIG. 5c in which the concept of FIG 5b is expanded, the voltage level V_{yd} is equal to each other in two neighbor subfields. More specifically, the voltage level V_{yd} is decreased at a constant ratio in stages for two subfields, without decreasing the voltage level V_{yd} as a constant ratio for each subfield, as shown in FIG. 5b. This embodiment illustrates only the case in which the voltage level V_{yd} is decreased in stages for two subfields, as shown in FIG. 5c, but it may be applied to a unit of three or more subfields.

FIG. 5 explains the case in which the change of the voltage level V_{yd} is applied to only one frame, but it may be applied to plural frames. For example, after the voltage level V_{yd} is gradually decreased in a unit of each Y electrode according to the scanning sequence from the first subfield of the first frame to the last subfield of the second frame, as shown in FIG 5a, the voltage level V_{yd} in the first subfield of the third frame is reset as the level of first subfield of the first frame again, and is gradually decreased till the last subfield of the fourth frame. In this case, it is preferable that the reset period containing both ramp-up period and ramp-down period is one per two frames. As such, it can obtain the higher contrast ratio, and since the time to apply the sustain discharge pulse is prolonged, it can obtain the higher luminance.

Although FIGS. 5b and 5c illustrate that the voltage to be decreased in stages has a constant width, the width may be set differently for each step.

FIG. 6 is a diagram of the waveform applied to the Y electrode according to a second embodiment of the present invention.

The voltage level V_{ys} of the Y electrode selected at the scanning in the addressing period of each subfield is varied (decreased) according to the voltage levels V_{yd-1}, . . . , and V_{yd-n} at the ending point of the ramp-down, but the voltage level V_{yb} of the non-selected Y electrodes is constantly maintained in all subfields. Accordingly, the voltage difference V_{g} between two voltages V_{ys} and V_{yb} is gradually increased as V_{g1}, V_{g2}, . . . , V_{gn}, according to the progress sequence of the subfield, as shown in FIG. 6.

In case in which the voltage level of the Y electrode at the ending point of the ramp-down is varied as shown in FIG. 5, the voltage difference V_{g} is increased at a constant slope contrary to FIG. 5, or is gradually increased in a unit of one subfield or two subfields.

By gradually increasing the difference between the voltage V_{ys} of the selected Y electrode and the voltage level V_{yb} of the non-selected Y electrodes according to the progress of the subfield, it can surely prevent the neighbor non-selected Y electrode from being interfered with the selected Y electrode.

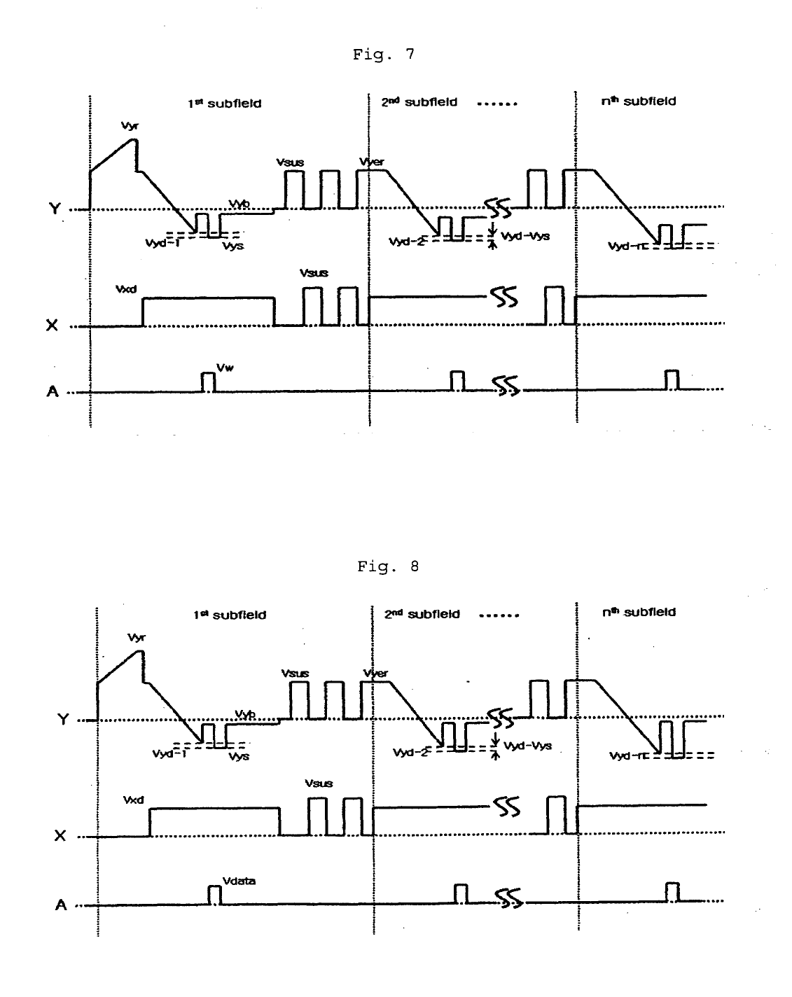

FIGS. 7 and 8 are diagrams of the waveform applied to the Y electrode according to a third embodiment of the present invention.

In order to smoothly carry out the discharge in the address period, the voltage level V_{yd} of the Y electrode at the ending point of the ramp-down is gradually decreased as shown in FIG. 5, and simultaneously, the voltage level V_{ys} of the selected Y electrode in the address period is applied a level lower than the voltage level V_{yd-1}, . . . , V_{yd-n} of the Y electrode at the ending point of the ramp-down in the reset period.

More specifically, although the voltage level V_{y}, of the selected Y electrode in the address period is equal to the voltage level V_{yd-1}, . . . , V_{yd-n} of the Y electrode at the ending point of the ramp-down in the reset period, in the above embodiments, the voltage level V_{ys} is applied at a predetermined level in this embodiment. As such, the voltage Vₐ applied between the electrodes is further increased by V_{ys}-V_{yd} in comparison with the above embodiments, thereby smoothly carrying out the address discharge. Consequently, the time required for the address discharge can be shortened.

FIG. 7 illustrates the case in which the voltage difference between the voltage level V_{ys}of the Y electrode selected in the address period and the voltage level V_{yb} of the Y electrode not electrode is constantly maintained as V_{g}, as shown in FIG, 4, and FIG. 8 illustrates the case in which the voltage difference is gradually increased as V_{g1}, V_{g2}, . . . , V_{gn}, as shown in FIG. 6.

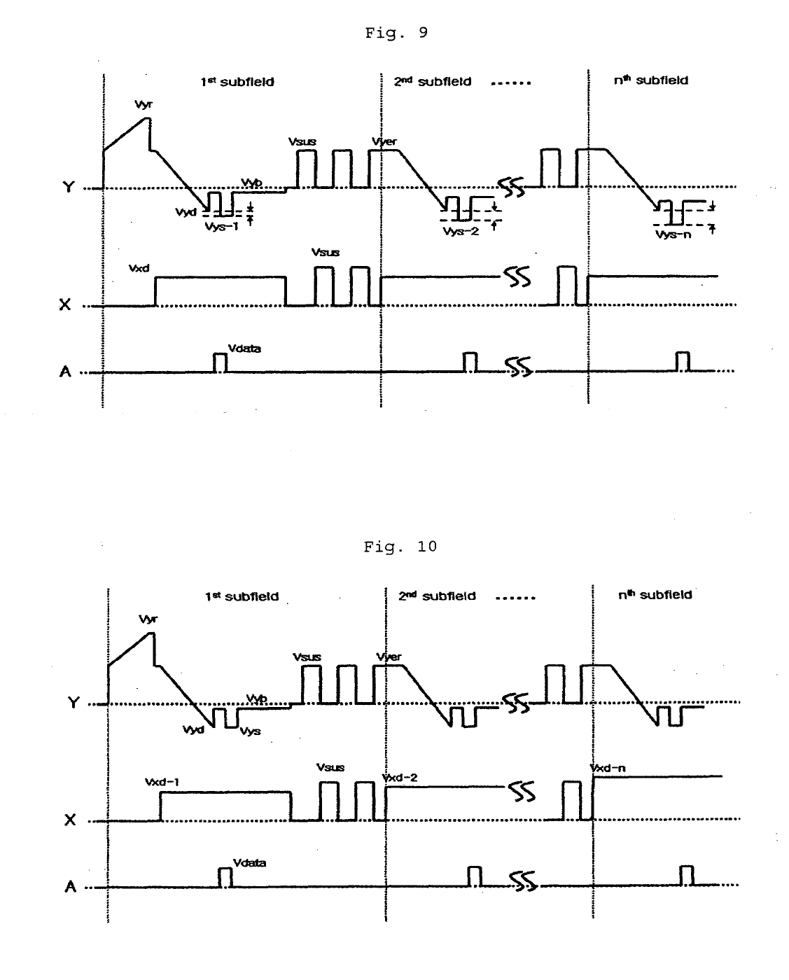

FIG. 9 is a diagram of the waveform applied to the Y electrode according to a fourth embodiment of the present invention.

Although the voltage level V_{yd} of the Y electrode at the ending point of the ramp-down is decreased according to the progress of the subfield, as shown in FIG. 5, in the above embodiments, the voltage level V_{yd} is constantly maintained, and the voltage level V_{ys} of the Y electrode selected in the address period is gradually decreased as V_{ys-1}, V_{ys-2}, . . . , V_{ys-n} according to the progress of subfield, in this embodiment.

The voltage level V_{yb} of the non-selected Y electrode is reduced by the decreased voltage level of the selected Y electrode, thereby constantly maintaining the difference of the voltage level between the selected Y electrode and the non-selected Y electrode, irrespective of the progress of the subfield (method corresponding to FIG. 7). In addition, by constantly maintaining the voltage level V_{yb} of the non-selected Y electrode in the address period, irrespective of the progress of the subfield, the difference of the voltage level between the selected Y electrode and the non-selected Y electrode may be gradually increased according to the progress of the subfield (method corresponding to FIG. 8).

By gradually increasing the difference between the voltage level V_{yd} of the Y electrode at the ending point of ramp-down and the voltage level V_{ys-1},V_{ys-2}, . . . , and V_{ys-n} of the Y electrode selected in the address period according to the progress of the subfield, the voltage level V_{yd} of the Y electrode at the ending point of the ramp-down is not varied according to the progress of the subfield, as the prior art. Consequently, although the OFF cell in which the sustain discharge does not occur in the previous subfield is not discharged again, the address discharge characteristic can be improved. Regard is paid to the fact that the conditions of the address discharge become worse according to the progress of the subfield in the OFF cell.

In this instance, the voltage level V_{ys-1}, V_{ys-2}, . . . , and V_{ys-n} of each Y electrode selected in the address period may be changed as the shapes shown in FIG. 5.

The above embodiments disclose the methods of improving the waveform of the pulse applied to the Y electrode to obtain the stable and rapid address characteristic, the high contrast ratio, and the high luminance. However, the same effects can be obtained by reforming the waveform of the pulse applied to the X electrode.

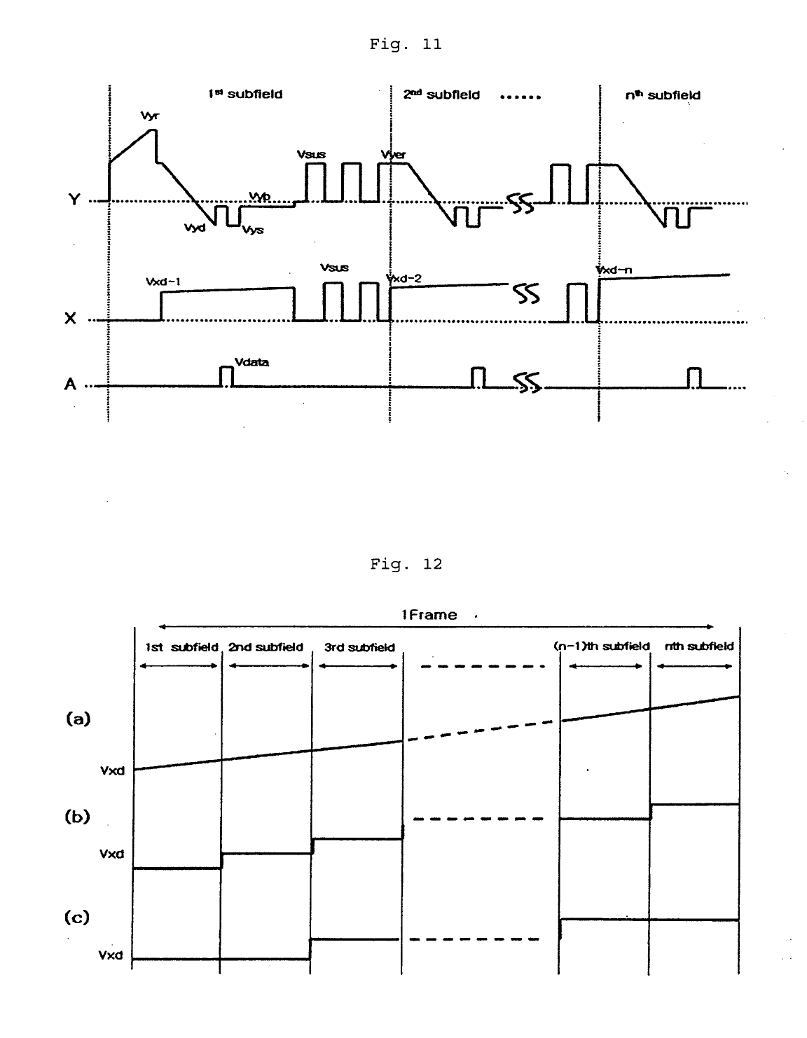

FIGS. 10 and 11 are diagrams of the waveform of the pulse applied to the X electrode according to a fifth embodiment of the present invention.

In the embodiment shown in FIG. 4, the relation between each electrode at the ending point of the ramp-down should satisfy Equations 1 and 2, and the relations between X and Y electrodes and between A and Y electrodes should satisfy Equations 3 and 4.

More specifically, there is a method of gradually decreasing the voltage level V_{yd} of the Y electrode at the ending point of the ramp-down, as described in the above embodiments, so as to increase the applied voltage Vₐ at the ending point of the ramp-down. By contrast, the purpose can be achieved by gradually increasing the voltage level V_{xd} of the X electrode, as shown in FIGS. 10 and 11. In this instance, FIG. 10 illustrates the case in which the voltage has the same level in the same subfield and the voltage level is increased in stages according to the progress of the subfield, while FIG. 11 illustrates the case in which the voltage level is increased according to the progress of the subfield and is gradually increased in the same subfield.

However, as can be known from Equations 3 and 4, the increased voltage of the X electrode increases theoretically the voltage applied between X and Y electrodes, and the voltage applied between A and Y electrodes is not increased. More specifically, if the voltage level V_{yd} of the Y electrode is decreased according to the progress of the subfield to further decrease the applied voltage Vₐ, the OFF cell in the previous subfield causes the discharge between X and Y electrodes and between A and Y electrodes in the ramp-down. However, by further increasing the voltage level V_{xd} of the X electrode according to the progress of the subfield to add the applied voltage Vₐ, the OFF cell in the previous subfield may cause the discharge only between X and Y electrodes in the ramp-down. However, even though the discharge occurs between X and Y electrodes, there are effects of compensating the spatial charge loss of the OFF cell and the jitter of the wall charges with the lapse of time, thereby obtaining the stable and rapid address condition.

The method of increasing the voltage level V_{xd} of the X electrode according to the progress of the subfield is illustrated in FIG. 12, and the principle is substantially identical to that of FIG. 5, except for the increased voltage. The applied scope can be expanded to not one frame but a plurality of frames, as described above. In addition, although not shown in the drawings, other features may be applied to this embodiment, as well as the feature of gradually decreasing the voltage level V_{yd} in the waveform of the pulse applied to the Y electrode.

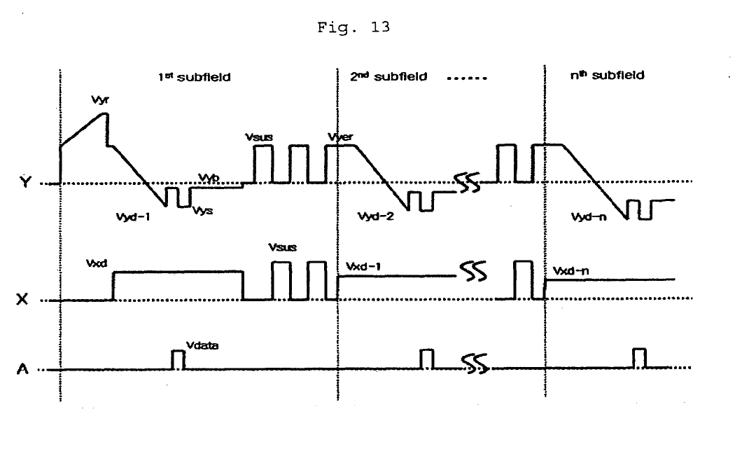

FIG. 13 is a diagram illustrating the waveform of the pulse according to a sixth embodiment of the present invention.

As expressed in Equations 1 and 3, the discharge amount at the ramp-down is varied according to the applied voltage V_{axy}, and the dimension of the wall voltage V_{wxy} generated at the ending point of the ramp-down is also varied. In this instance, if the applied voltage Vₐ is too low, the wall voltage is largely generated in case the X electrode is an anode. By contrast, if the applied voltage Vₐ is too high, the wall voltage is largely generated in case the Y electrode is an anode. If the wall voltage V_{w} generated in the reset period is excessively high, the cell to be off due to that the address discharge does not occur may be probably mis-discharged by the sustain pulse in the subsequent sustain period.

In the above embodiments, in case of applying the method of decreasing the voltage level V_{yd} of the Y electrode at the ending point of the ramp-down according to the progress of the subfield, if the applied voltage is increased, the high wall voltage may be generated if the Y electrode is an anode. Consequently, this embodiment reduces the voltage level V_{yd} of the Y electrode according to the progress of the subfield, and also decreases the voltage level V_{xd} of the X electrode, thereby suppressing that the high wall voltage is generated if the Y electrode of X and Y electrodes is an anode and thus enlarging a voltage margin in the sustain period.

As expressed in Equations 2 and 4, to reduce the voltage level V_{xd} of the X electrode according to the progress of the subfield does not exert influence on the voltage V_{aay} applied between A and Y electrodes. Consequently, the OFF cell, in which the sustain discharge does not occur in the previous subfield, may cause the discharge between A and Y electrodes by the voltage V_{yd} of the Y electrode in the ramp-down of the subsequent subfield. If the reduced degree of the voltage level V_{yd} of the Y electrode is identical to the reduced degree of the voltage level V_{xd} of the X electrode, the discharge does not occur between X and Y electrodes, and the discharge occurs between A and Y electrodes. If the decreased degree of V_{xd} is small, the discharge may occur between X and Y electrodes. In this instance, the reduction ratio of the voltage level V_{yd} of the Y electrode to the voltage level V_{xd} of the X electrode may be identically or differently determined depending upon the electrical discharge characteristic of the applied panel. The relations (V_{ys}, V_{yb}, V_{yd}, and the like) between the voltages applied to the Y electrode, i.e., the shape of waveform, may be applied in various modes to reduce V_{y} according to the progress of the subfield, as described embodiments.

Although the above embodiments explain the case in which the reset period containing both ramp-up period and ramp-down period is one, the reset period containing both ramp-up period and ramp-down period may be set in plural depending upon the discharge characteristic of the panel. In this instance, according to the progress of the subfield, V_{yd} or V_{ys} starts to decrease or increase from the subfield containing both first ramp-up and ramp-down, and is maintained till the second subfield containing both second ramp-up and ramp-down. And, in the second subfield containing both second ramp-up and ramp-down, V_{yd} or V_{ys} is set to have the same level as the first subfield containing both first ramp-up and ramp-down. The above process is repeated by the number of the subfields containing both ramp-up and ramp-down. As such, if the number of the subfields containing both ramp-up and ramp-down in the reset period is increased, the contrast ratio may be somewhat unfavorable, but the address discharge characteristic is improved. Consequently, the time required for the address discharge can be shortened.

In case a plurality of the subfield containing both ramp-up and ramp-down are applied to one frame, the voltage level V_{yr} can be differently set at the ending point of the ramp-up.

In addition, the position of the subfield containing both ramp-up and ramp-down may be differently set depending upon the electrical characteristic of the panel. For example, if the subfield containing both ramp-up and ramp-down is applied to one frame once, the position may be not applied to the first subfield, but applied to other subfield depending upon the electrical characteristic of the panel.

With the above description, the method of driving the plasma display panel according to the present invention can improve the stable and rapid address discharge characteristic of the plasma display panel by reforming the waveform of the pulse applied to the Y electrode or X electrode and also can increase the luminance of the plasma display panel and maintain the high contrast ratio.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method of driving a plasma display panel including one frame divided into a plurality of subfields, the subfield being classified into a reset period, an address period, and a sustain period in order to display a gray scale of the panel by discharge of the subfields, the method comprising the steps of:
gradually decreasing a voltage level of a scan electrode (Y electrode) at a ending point of ramp-down in each reset period, according to progress of the subfields.

2. A method of driving a plasma display panel including one frame divided into a plurality of subfields, the subfield being classified into a reset period, an address period, and a sustain period in order to display a gray scale of the panel by discharge of the subfields, the method comprising the steps of:
gradually decreasing a voltage level of a scan pulse applied to a scan electrode selected at scanning in each address period, according to progress of the subfields.

3. The method of driving the plasma display panel as claimed in claim 1, wherein a difference between a voltage level of the scan pulse applied to a selected scan electrode and a voltage level of the scan pulse applied to non-selected scan electrode is constantly maintained in all subfields.

4. The method of driving the plasma display panel as claimed in claim 1, wherein a voltage level of the scan pulse applied to non-selected scan electrode is constantly maintained in the address period.

5. The method of driving the plasma display panel as claimed in claim 1, wherein a voltage level of the scan pulse at the ending point of the ramp-down and a voltage level of the scan pulse applied to a scan electrode selected in the address period are gradually decreased for each scan electrode from a first subfield to a last subfield, according to a scanning sequence.

6. The method of driving the plasma display panel as claimed in claim 5, wherein a variation rate of the voltage level to be decreased according to the scanning sequence is constant from the first subfield to the last subfield.

7. The method of driving the plasma display panel as claimed in claim 5, wherein a variation rate of the voltage level to be decreased according to the scanning sequence is differently set for each subfield.

8. The method of driving the plasma display panel as claimed in claim 5, wherein one reset period containing both ramp-up and ramp-down is existed in at least one frame, and only ramp-down is existed in the remaining reset period.

9. The method of driving the plasma display panel as claimed in claim 5, wherein a plurality of reset periods containing both ramp-up and ramp-down are existed in at least one frame, and only ramp-down is existed in the remaining reset period.

10. The method of driving the plasma display panel as claimed in claim 1, wherein a voltage level of the scan pulse at the ending point of the ramp-down and a voltage level of the scan pulse applied to a scan electrode selected in the address period have the same level in the same subfield and are gradually decreased in stages in a unit of at least one frame, according to progress of the subfield.

11. The method of driving the plasma display panel as claimed in claim 10, wherein a width of the voltage to be differently decreased is set for each stage.

12. The method of driving the plasma display panel as claimed in claim 10, wherein one reset period containing both ramp-up and ramp-down is existed in at least one frame, and reset period containing only ramp-down is existed in the remaining reset period in other subfields.

13. The method of driving the plasma display panel as claimed in claim 10, wherein a plurality of reset periods containing both ramp-up and ramp-down are existed in at least one frame, and only ramp-down is existed in the remaining reset period.

14. The method of driving the plasma display panel as claimed in claim 1, wherein a voltage level of the scan pulse at the ending point of the ramp-down and a voltage level of the scan pulse applied to a scan electrode selected in the address period have the same level in at least two neighbor subfield and are gradually decreased in stages in a unit of at least one frame, according to progress of the subfield.

15. The method of driving the plasma display panel as claimed in claim 14, wherein a width of the voltage to be decreased is differently set for each stage.

16. The method of driving the plasma display panel as claimed in claim 14, wherein one reset period containing both ramp-up and ramp-down is existed in at least one frame, and only ramp-down is existed in the remaining reset period.

17. The method of driving the plasma display panel as claimed in claim 14, wherein a plurality of reset periods containing both ramp-up and ramp-down are existed in at least one frame, and only ramp-down is existed in the remaining reset period.

18. The method of driving the plasma display panel as claimed in claim 1, wherein a voltage level of a sustain electrode (X electrode) is gradually decreased in a ramp-down period and the address period, according to progress of the subfield.

19. The method of driving the plasma display panel as claimed in claim 1, wherein a scan pulse applied to a selected scan electrode has the same level as the voltage level of the scan electrode at the ending point of the ramp-down in the address period.

20. The method of driving the plasma display panel as claimed in claim 1, wherein a scan pulse applied to a selected scan electrode is set as a level lower than the voltage level of the scan electrode at the ending point of the ramp-down in the address period.

21. The method of driving the plasma display panel as claimed in claim 19, wherein a difference between a voltage of the scan pulse applied to the selected scan electrode and a voltage of a scan pulse applied to a non-selected scan electrode is constantly maintained in the address period.

22. The method of driving the plasma display panel as claimed in claim 19, wherein a voltage level of a scan pulse applied to a non-selected scan electrode is constantly maintained in the address period.

23. The method of driving the plasma display panel as claimed in claim 2, herein a difference between a voltage level of the scan pulse applied to a selected scan electrode and a voltage level of the scan pulse applied to non-selected scan electrode is constantly maintained in all subfields.

24. The method of driving the plasma display panel as claimed in claim 2, wherein a voltage level of the scan pulse applied to non-selected scan electrode is constantly maintained in the address period.

25. The method of driving the plasma display panel as claimed in claim 2, wherein a voltage level of the scan pulse at the ending point of the ramp-down and a voltage level of the scan pulse applied to a scan electrode selected in the address period have the same level in the same subfield and are gradually decreased in stages in a unit of at least one frame, according to progress of the subfield.

26. The method of driving the plasma display panel as claimed in claim 25, wherein a width of the voltage to be decreased is differently set for each stage.

27. The method of driving the plasma display panel as claimed in claim 25, wherein one reset period containing both ramp-up and ramp-down is existed in at least one frame, and only ramp-down is existed in the remaining reset period.

28. The method of driving the plasma display panel as claimed in claim 25, wherein a plurality of reset periods containing both ramp-up and ramp-down are existed in at least one frame, and only ramp-down is existed in the remaining reset period.

29. The method of driving the plasma display panel as claimed in claim 2, wherein a voltage level of the scan pulse at the ending point of the ramp-down and a voltage level of the scan pulse applied to a scan electrode selected in the address period have the same level in at least two neighbor subfield and are gradually decreased in stages in a unit of at least one frame, according to progress of the subfield.

30. The method of driving the plasma display panel as claimed in claim 29, wherein a width of the voltage to be decreased is differently set for each stage.

31. The method of driving the plasma display panel as claimed in claim 29, wherein one reset period containing both ramp-up and ramp-down is existed in at least one frame, and only ramp-down is existed in the remaining reset period.

32. The method of driving the plasma display panel as claimed in claim 29, wherein a plurality of reset periods containing both ramp-up and ramp-down are existed in at least one frame, and only ramp-down is existed in the remaining reset period.

33. The method of driving the plasma display panel as claimed in claim 2, wherein a voltage level of a sustain electrode (X electrode) is gradually decreased in a ramp-down period and the address period, according to progress of the subfield.
